(19) United States
(12) Patent Application Publication
(10) Pub. No.: US 2026/0204230 A1
(43) Pub. Date: Jul. 16, 2026

(54) ELECTRONIC DEVICE

(71) Applicant: Samsung Display Co., LTD., Yongin-si (KR)

(72) Inventors: Sangmin LEE, Yongin-si (KR); SE-BYUNG CHAE, Yongin-si (KR); JUNSEOK NA, Yongin-si (KR)

(21) Appl. No.: 19/348,450

(22) Filed: Oct. 2, 2025

(30) Foreign Application Priority Data
Jan. 14, 2025 (KR) 10-2025-0005555

(51) Int. Cl. G09G 3/3275

(52) U.S. Cl. CPC G09G 3/3275; G09G 2310/0289; G09G 2320/0276

(57) ABSTRACT

An electronic device includes a display panel including a plurality of pixels, and a data driving circuit which outputs a data voltage. The data driving circuit includes an input unit which receives a plurality data from an outside and outputs a data signal composed of a plurality of bits, a first multiplexer which receives a first signal having x upper bit data among the plurality of bits, a second multiplexer which receives a second signal having y lower bit data among the plurality of bits, and a source output unit which receives the first signal from the first multiplexer and the second signal from the second multiplexer and generates the data voltage. A first output delay value of the first signal is different from a second output delay value of the second signal.

This application claims priority to Korean Patent Application No. 10-2025-0005555, filed on Jan. 14, 2025, and all the benefits accruing therefrom under 35 U.S.C. § 119, the content of which in its entirety is herein incorporated by reference.

### BACKGROUND

### (1) Field

The present disclosure herein relates to an electronic device with improved display quality.

### (2) Description of the Related Art

Multimedia electronic devices such as a smart watch, a television, a mobile phone, a tablet computer, a navigation unit, and a game console have a display device for displaying an image. The display device includes a display panel and a panel driving circuit. The panel driving circuit includes a data driving circuit for providing data voltages to a plurality of data lines, a scan driving circuit for providing scan signals to a plurality of scan lines, and an emission control circuit for providing emission control signals to a plurality of emission control lines.

### SUMMARY

The present disclosure provides an electronic device with improved display quality.

An embodiment of the invention provides an electronic device including: a display panel including a plurality of pixels electrically connected to one data line; and a data driving circuit which outputs a data voltage to the one data line, where the data driving circuit includes an input unit which receives a plurality of data from an outside and outputs a data signal composed of a plurality of bits, a first multiplexer which receives a first signal including x upper bit data among the plurality of bits, a second multiplexer which receives a second signal including y lower bit data among the plurality of bits, and a source output unit which receives the first signal from the first multiplexer and the second signal from the second multiplexer and generates the data voltage, where a first output delay value of the first signal output from the first multiplexer is different from a second output delay value of the second signal output from the second multiplexer.

In an embodiment, the data driving circuit may further include a decoder which converts the data signal to the first signal and outputs the first signal to the first multiplexer.

In an embodiment, the data driving circuit may further include a first storage unit in which a gamma reference value is stored, and the decoder may convert the data signal using the gamma reference value.

In an embodiment, each of the first output delay value and the second output delay value may be a value delayed from a level change point of a horizontal synchronization signal.

In an embodiment, the data driving circuit may further include a second storage unit in which the first output delay value and the second output delay value are stored.

In an embodiment, the second multiplexer may be which further receive a third signal including y interpolation bit data, and the third signal may be output subsequently to the second signal.

In an embodiment, the data driving circuit may further include a third storage unit in which the y interpolation bit data is stored.

In an embodiment, the plurality of pixels may include a plurality of red pixels and a plurality of blue pixels arranged in a first direction, and the plurality of red pixels and the plurality of blue pixels may be wherein each of x and y is an integer greater than or equal to 1, and arranged one by one along the first direction.

In an embodiment, the source output unit may receive the first signal and the third signal and further generate an interpolation data voltage.

In an embodiment, the data driving circuit may further include: a determination unit which determines x value and y value of the x upper bit data and the y lower bit data, respectively; and a fourth storage unit in which the x value and the y value are stored.

In an embodiment, the input unit may further include: a shift register unit which outputs a plurality of clock signals sequentially; a sampling latch unit which stores the plurality of data sequentially in response to the plurality of clock signals; and a holding latch unit which receives a load signal and output the plurality of data received from the sampling latch unit in response to the load signal.

In an embodiment, the input unit may further include a level shifter which receives the plurality of data from the holding latch unit and changes voltage levels of the plurality of data.

In an embodiment of the invention, an electronic device includes: a display panel including a first pixel electrically connected to one data line, and a second pixel connected to the one data line and arranged adjacent to the first pixel in a first direction; and a data driving circuit which provides a first data voltage to the first pixel and provides a second data voltage to the second pixel, where the data driving circuit includes an input unit which receives a plurality of data from an outside and outputs a data signal composed of a plurality of bits, a first multiplexer which receive a first signal including x upper bit data among the plurality of bits, a second multiplexer which receives a second signal including y lower bit data among the plurality of bits and receives a third signal including y interpolation bit data separately stored, and a source output unit which receive the first signal and the second signal to generate the first data voltage and the second data voltage, and which receives the first signal and the third signal to generate an interpolation data voltage, where a first output delay value of the first signal output from the first multiplexer is different from a second output delay value of the second signal output from the second multiplexer, and each of the first output delay value and the second output delay value is a value delayed from a level change point of a horizontal synchronization signal.

In an embodiment, the data driving circuit may further include a decoder which converts the data signal to the first signal and outputs the first signal to the first multiplexer.

In an embodiment, the data driving circuit may further include a first storage unit in which a gamma reference value is stored, and the decoder may convert the data signal using the gamma reference value.

In an embodiment, the data driving circuit may further include a second storage unit in which the first output delay value and the second output delay value are stored.

In an embodiment, the third signal may be output subsequently to the second signal.

In an embodiment, the data driving circuit may further include: a determination unit which determine x value and y value of the x upper bit data and the y lower bit data, respectively; and a fourth storage unit in which the x value and the y value are stored.

In an embodiment, the input unit may further include: a shift register unit which outputs a plurality of clock signals sequentially; a sampling latch unit which stores the plurality of data sequentially in response to the plurality of clock signals; a holding latch unit which receives a load signal and output the plurality of data received from the sampling latch unit in response to the load signal; and a level shifter which receives the plurality of data from the holding latch unit and changes voltage levels of the plurality of data.

In an embodiment of the invention, an electronic device includes: a display panel including a plurality of pixels electrically connected to one data line; a processor which outputs a control signal to control an operation of the display panel; a memory in which an x value and a y value are stored; an input unit which receives a bit determination signal including the x value and the y value from the memory based on the control signal, and outputs a first data signal including x upper bit data and a second data signal including y lower bit data; a first multiplexer which receives a first signal based on the first data signal; a second multiplexer which receives a second signal based on the second data signal; and a source output unit which receives the first signal from the first multiplexer and the second signal from the second multiplexer and generates a data voltage, where a first output delay value of the first signal output from the first multiplexer is different from a second output delay value of the second signal output from the second multiplexer.

### BRIEF DESCRIPTION OF THE DRAWINGS

The above and other features of embodiments of the invention will become more apparent by describing in further detail embodiments thereof with reference to the accompanying drawings, in which:

FIG. 1 is a block diagram of an electronic device according to an embodiment of the invention;

FIG. 2 is a block diagram of an electronic device according to an embodiment of the invention;

FIG. 3 is a view illustrating an arrangement of pixels according to an embodiment of the invention;

FIG. 4 is a circuit diagram of a pixel according to an embodiment of the invention;

FIG. 5 is a cross-sectional view of a display panel according to an embodiment of the invention;

FIG. 6 is a block diagram of a data driving circuit according to an embodiment of the invention;

FIG. 7 is a block diagram illustrating a portion of a data driving circuit according to an embodiment of the invention;

FIG. 8A is a table showing a bit number of each of a first data signal and a second data signal according to an embodiment of the invention;

FIG. 8B is a table showing a bit number of each of a first data signal and a second data signal according to an embodiment of the invention;

FIG. 9A is a signal timing diagram for describing a first output delay value and a second output delay value of signals according to an embodiment of the invention;

FIG. 9B is a signal timing diagram for describing a first output delay value and a second output delay value of signals according to an embodiment of the invention; and

FIG. 10 is a signal timing diagram for describing a (1-1)-th signal, a second signal, and a third signal according to an embodiment of the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that when an element (or a region, a layer, a portion, or the like) is referred to as being “connected to” or “coupled to” another element, it may be directly connected to, or coupled to the other element, or other elements may be disposed therebetween.

Like reference numerals or symbols refer to like elements throughout. In the drawings, the thickness, ratio, and size of the elements are exaggerated for effectively describing the technical contents.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof . . .

The wording a “part” or a “unit” refers to a software component or a hardware component performing a specific function. A hardware component may include, for example, a field-programmable gate array (FPGA) or an application-specific integrated circuit (ASIC). A software component may refer to data used by an executable code and/or an executable code in an addressable storage medium. Therefore, software components may be, for instance, object-oriented software components, class components, and work components, and may include processes, functions, properties, procedures, sub-routines, program code segments, driving circuits, firmware, micro-codes, circuits, data, database, data structures, tables, arrangements, or variables.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention are described with reference to the accompanying drawings.

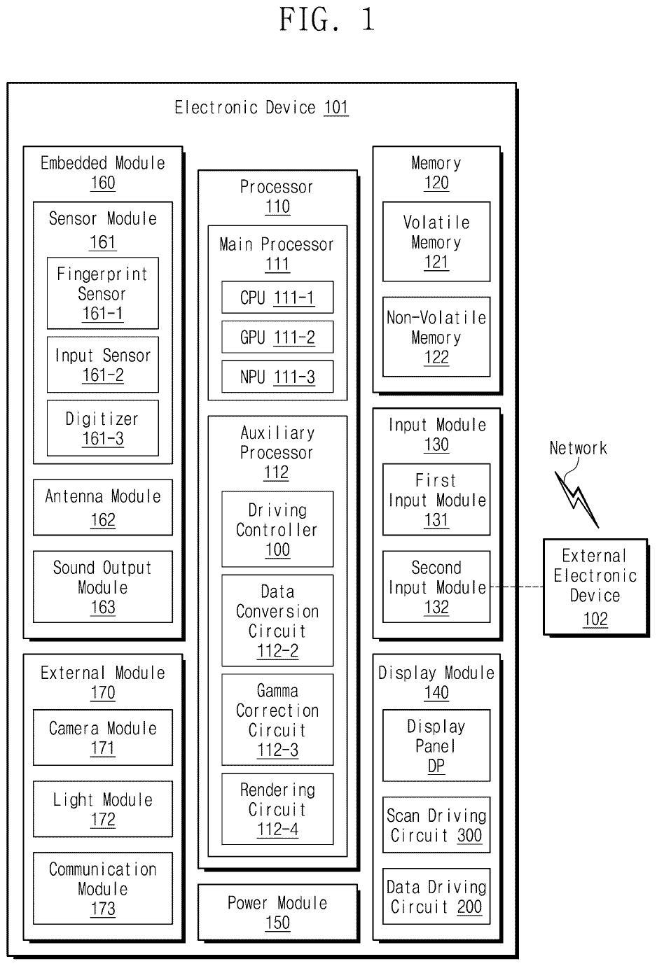

FIG. 1 is a block diagram of an electronic device 101 according to an embodiment of the invention.

Referring to FIG. 1, in an embodiment the electronic device 101 may output various information, within an operating system, using a display module 140. When a processor 110 executes an application stored in a memory 120, the display module 140 provides application information to a user through a display panel DP.

The processor 110 acquires an external input through an input module 130 or a sensor module 161, and executes an application corresponding to the external input. In an embodiment, for example, when a user selects a camera icon displayed on the display panel DP, the processor 110 acquires a user input through an input sensor 161-2 and activates a camera module 171. The processor 110 transfers, to the display module 140, image data corresponding to a captured image acquired by the camera module 171. The display module 140 may display an image corresponding to the captured image through the display panel DP.

In an embodiment, for example, when personal information authentication is executed in the display module 140, a fingerprint sensor 161-1 acquires fingerprint information input thereto as input data. The processor 110 compares the input data acquired by the fingerprint sensor 161-1 with authentication data stored in the memory 120, and executes an application according to the comparison results. The display module 140 may display, through the display panel DP, information that is executed according to the logic of the application.

In an embodiment, for example, when a music streaming icon displayed on the display module 140 is selected, the processor 110 acquires a user input through the input sensor 161-2 and activates a music streaming application stored in the memory 120. When a music execution command is input to the music streaming application, the processor 110 activates a sound output module 163 to provide, to the user, sound information corresponding to the music execution command.

Various operations of the electronic device 101 are briefly described above as examples. Hereinafter, the configuration of the electronic device 101 will be described in detail. Some components of the electronic device 101 to be described later may be integrated into one component, and one component may be divided into two or more components.

Referring to FIG. 1, an embodiment of the electronic device 101 may communicate with an external electronic device 102 through a network (for example, a short-range wireless communication network or a long-range wireless communication network). According to an embodiment, the electronic device 101 may include the processor 110, the memory 120, the input module 130, the display module 140, a power module 150, an embedded module 160, and an external module 170. According to an embodiment, at least one selected from the aforementioned components may be omitted from the electronic device 101, or one or more other components may be added to the electronic device 101. According to an embodiment, some components (for example, the sensor module 161, an antenna module 162, or the sound output module 163) among the aforementioned components may be integrated into another component (for example, the display module 140).

The processor 110 may execute software to control at least one other component (for example, a hardware or software component), of the electronic device 101, connected to the processor 110, and may perform various data processing or computations. According to an embodiment, as at least a part of data processing or computations, the processor 110 may store a command or data received from another component (for example, the input module 130, the sensor module 161, or a communication module 173) in a volatile memory 121, process a command or data stored in the volatile memory 121, and store result data in a non-volatile memory 122.

The processor 110 may include a main processor 111 and an auxiliary processor 112. The main processor 111 may include at least one selected from a central processing unit (CPU) 111-1 and an application processor AP. The main processor 111 may further include at least one selected from a graphic processing unit (GPU) 111-2, a communication processor (CP), and an image signal processor (ISP). The main processor 111 may further include a neural processing unit (NPU) 111-3. The neural processing unit is a processor specialized in processing an artificial intelligence model, and the artificial intelligence model may be created through machine learning. The artificial intelligence model may include a plurality of artificial neural network layers. The artificial neural network may be one among a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, or a combination of two or more therefrom, but an embodiment of the invention is not limited to aforementioned examples. The artificial intelligence model may include additionally or alternatively a software structure in addition to a hardware structure. At least two selected from the aforementioned processing unit and the processor may be implemented as one integrated component (for example, a single-chip), or as individual components (for example, a plurality of chips).

The auxiliary processor 112 may include a driving controller 100. The driving controller 100 may include an interface conversion circuit and a timing control circuit. The driving controller 100 receives an image signal from the main processor 111, converts the data format of the image signal to comply with the interface specifications with the display module 140, and outputs image data. The driving controller 100 may output various control signals required for driving the display module 140.

The auxiliary processor 112 may further include a data conversion circuit 112-2, a gamma correction circuit 112-3, a rendering circuit 112-4, and the like. The data conversion circuit 112-2 may receive image data from the driving controller 100 and compensate the image data so that an image is displayed with a desired brightness according to a user's setting or the characteristics of the electronic device 101, or may convert the image data for reduction in power consumption, compensation of an afterimage, etc. The gamma correction circuit 112-3 may convert image data, a gamma reference voltage, or the like so that an image displayed on the electronic device 101 has a desired gamma property. The rendering circuit 112-4 may receive image data from the driving controller 100 and render the image data in consideration of a pixel arrangement and the like, of the display panel DP applied to the electronic device 101. At least one selected from the data conversion circuit 112-2, the gamma correction circuit 112-3, and the rendering circuit 112-4 may be integrated into another component (for example, the main processor 111 or the driving controller 100). At least one selected from the data conversion circuit 112-2, the gamma correction circuit 112-3, and the rendering circuit 112-4 may be integrated into a data driving circuit 200 to be described later.

The memory 120 may store various data used by at least one component (for example, the processor 110 or the sensor module 161) of the electronic device 101, and input data or output data about a command related thereto. The memory 120 may include at least one selected from the volatile memory 121 and the non-volatile memory 122.

The input module 130 may receive, from the outside (for example, a user or an external electronic device 102) of the electronic device 101, a command or data to be used for a component (for example, the processor 110, the sensor module 161, or the sound output module 163) of the electronic device 101.

The input module 130 may include a first input module 131 to which a command or data is input by a user, and a second input module 132 to which a command or data is input by the external electronic device 102. The first input module 131 may include a microphone, a mouse, a keyboard, a key (for example, a button), or a pen (for example, a passive pen or an active pen). The second input module 132 may support a designated protocol which may be connected with the external electronic device 102 in a wired or wireless manner. According to an embodiment, the second input module 132 may include a high-definition multimedia interface (HDMI), a universal serial bus (USB) interface, an SD card interface, or an audio interface. The second input module 132 may include a connector capable of physical connection with the external electronic device 102, and include, for example, an HDMI connector, a USB connector, an SD card connector, or an audio connector (for example, a headphone connector).

The display module 140 provides information visually to a user. The display module 140 may include the display panel DP, a scan driving circuit 300, and a data driving circuit 200. The display module 140 may further include a window, a chassis, and a bracket for protecting the display panel DP.

The display panel DP may include a liquid crystal display panel, an organic light-emitting display panel, or an inorganic light-emitting display panel, and the type of the display panel DP is not particularly limited. The display panel DP may be a rigid type panel, or a flexible type panel which is rollable or foldable. The display module 140 may further include a support for supporting the display panel DP, a bracket, a heat dissipation member, or the like.

The scan driving circuit 300 may be mounted as a driving chip in the display panel DP. In addition, the scan driving circuit 300 may be integrated in the display panel DP. In an embodiment, for example, the scan driving circuit 300 may include an amorphous silicon TFT gate driver circuit (ASG), a low temperature polycrystalline silicon (LTPS) TFT gate driver circuit, or an oxide semiconductor TFT gate driver circuit (OSG) embedded in the display panel DP. The scan driving circuit 300 receives a control signal from the driving controller 100 and outputs scan signals to the display panel DP in response to the control signal.

The display panel DP may further include an emission driving circuit. The emission driving circuit outputs an emission control signal to the display panel DP in response to the control signal received from the driving controller 100. The emission driving circuit may be formed separately from the scan driving circuit 300 or may be integrated into the scan driving circuit 300.

The data driving circuit 200 receives a control signal from the driving controller 100, converts image data to an analog voltage (for example, a data voltage) in response to the control signal, and then outputs data voltages to the display panel DP. The data voltage, which is provided to a plurality of pixels connected to one data line, may be switched consecutively.

According to an embodiment of the invention, the data driving circuit 200 may receive control signals from storage units. In an embodiment, for example, the control signals may include a bit control signal and a timing control signal. The bit control signal may be a signal for controlling a bit number of each of upper bit data and lower bit data among a plurality of bits of data signals corresponding to two adjacent pixels. The timing control signal may be a signal for individually controlling an output timing of each of the upper bit data and the lower bit data. Thus, the data driving circuit 200 may control the respective output timings of the data signals corresponding to two adjacent pixels to be different from each other, and may provide a separately stored signal as an interpolation data voltage so that a data peak caused by superposition of the data voltages may be effectively prevented from occurring. Accordingly, the display quality of the electronic device 101 may be improved.

The data driving circuit 200 may be integrated into another component (for example, the driving controller 100). The functions of the interface conversion circuit and the timing control circuit of the driving controller 100 may be integrated into the data driving circuit 200.

The display module 140 may further include an emission driving circuit, a voltage generation circuit, and the like. The voltage generation circuit may output various voltages required for driving the display panel DP.

The power module 150 provides power to the components of the electronic device 101. The power module 150 may include a battery for charging a power voltage. The battery may include a primary cell which is not rechargeable, a secondary cell which is rechargeable, or a fuel cell. The power module 150 may include a power management integrated circuit (PMIC). The PMIC provides optimized power to each of the aforementioned modules and modules to be described later. The power module 150 may include a wireless power transmission and reception member electrically connected to the battery. The wireless power transmission and reception member may include a plurality of antenna radiators in a shape of a coil.

The electronic device 101 may further include an embedded module 160 and an external module 170. The embedded module 160 may include the sensor module 161, the antenna module 162, and the sound output module 163. The external module 170 may include the camera module 171, a light module 172, and the communication module 173.

The sensor module 161 may detect an input provided by a user's body or an input provided by a pen of the first input module 131, and may generate an electrical signal or a data value corresponding to the input. The sensor module 161 may include at least one selected from the fingerprint sensor 161-1, the input sensor 161-2, and a digitizer 161-3.

The fingerprint sensor 161-1 may generate a data value corresponding to a user's fingerprint. The fingerprint sensor 161-1 may include either an optical-type or a capacitive-type fingerprint sensor.

The input sensor 161-2 may generate a data value corresponding to coordinate information about an input provided by a user's body or an input provided by a pen.

The input sensor 161-2 may generate, as the data value, an amount of change in capacitance caused by the input. The input sensor 161-2 may detect an input provided by a passive pen or transmit/receive data to/from an active pen.

The input sensor 161-2 may measure a bio-signal such as blood pressure, body water, or body fat. In an embodiment, for example, when it is determined that if a user does not move for a certain period of time while a portion of the body is in contact with a sensor layer or a sensing panel, the input sensor 161-2 may detect a bio-signal on the basis of changes in an electric field caused by the portion of the body, and output information desired by the user to the display module 140.

The digitizer 161-3 may generate a data value corresponding to coordinate information about an input provided by a pen. The digitizer 161-3 generates, as a data value, an amount of electromagnetic change caused by an input. The digitizer 161-3 may detect input provided by a passive pen or transmit/receive data to/from an active pen.

At least one selected from the fingerprint sensor 161-1, the input sensor 161-2, and the digitizer 161-3 may be implemented as a sensor layer formed on the display panel DP through a continuous process. The fingerprint sensor 161-1, the input sensor 161-2, and the digitizer 161-3 may be disposed on an upper side of the display panel DP, and any one of the fingerprint sensor 161-1, the input sensor 161-2, and the digitizer 161-3, for example, the digitizer 161-3, may be disposed on a lower side of the display panel DP.

At least two selected from the fingerprint sensor 161-1, the input sensor 161-2, and the digitizer 161-3 may be formed through the same process to be integrated into one sensing panel. In an embodiment where the input sensor 161-2, and the digitizer 161-3 are integrated into one sensing panel, the sensing panel may be disposed between the display panel DP and a window disposed on the display panel DP. According to an embodiment, the sensing panel may be disposed on the window, and the position of the sensing panel is not particularly limited.

At least one selected from the fingerprint sensor 161-1, the input sensor 161-2, and the digitizer 161-3 may be embedded in the display panel DP. That is, through a process of forming elements (for example, a light-emitting element, a transistor, and the like.) included in the display panel DP, at least one selected from the fingerprint sensor 161-1, the input sensor 161-2, and the digitizer 161-3 may be formed simultaneously.

In addition, the sensor module 161 may generate an electrical signal or a data value corresponding to an internal state or an external state of the electronic device 101. In an embodiment, for example, the sensor module 161 may further include a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 162 may include one or more antennas for transmitting/receiving a signal or power to/from the outside. According to an embodiment, the communication module 173 may transmit/receive a signal to/from an external electronic device via an antenna suitable for a communication method. An antenna pattern of the antenna module 162 may be integrated into one component (for example, a display panel DP) of the display module 140, the input sensor 161-2, or the like.

The sound output module 163 may be a unit for outputting a sound signal to the outside of the electronic device 101. In an embodiment, for example, the sound output module may include a speaker used for general purposes such as multimedia playback or recording playback, and a receiver used exclusively for receiving phone calls. According to an embodiment, the receiver may be formed integrally with or separately from the speaker. The sound output pattern of the sound output module 163 may be integrated into the display module 140.

The camera module 171 may capture a static image or a dynamic image. According to an embodiment, the camera module 171 may include one or more lenses, an image sensor, or an image signal processor. The camera module 171 may further include an infrared light camera capable of measuring a user's presence/absence, a user's location, a user's gaze, and the like.

The light module 172 may provide light. The light module 172 may include a light-emitting diode or a xenon lamp. The light module 172 may operate in association with the camera module 171 or operate independently.

The communication module 173 may support establishing a wired or wireless communication channel between the electronic device 101 and the external electronic device 102, and support performing communication through the established communication channel. The communication module 173 may include a wireless communication module such as a cellular communication module, a short-range wireless communication module or a global navigation satellite system (GNSS) communication module, and/or a wired communication module such as a local area network (LAN) communication module or a power line communication module. The communication module 173 may communicate with the external electronic device 102 via a short-range communication network such as Bluetooth, WiFi direct, or infrared data association (IrDA), or via a long-range communication network such as a cellular network, the Internet, or a computer network (for example, LAN or WAN). Various types of the communication module 173 described above may be implemented as a single-chip or may be implemented as individual chips.

The input module 130, the sensor module 161, the camera module 171, and the like may be used, in association with the processor 110, to control an operation of the display module 140.

The processor 110 outputs a command or data to the display module 140, the sound output module 163, the camera module 171, or the light module 172 on the basis of the input data received from the input module 130. In an embodiment, for example, the processor 110 may generate image data corresponding to the input data applied through a mouse, an active pen, or the like and output the image data to the display module 140, or may generate command data corresponding to the input data and output the command data to the camera module 171 or the light module 172. When input data is not received from the input module 130 for a certain period of time, the processor 110 may switch an operation mode of the electronic device 101 to a low power mode or a sleep mode, thereby reducing power consumption of the electronic device 101.

The processor 110 outputs a command or data to the display module 140, the sound output module 163, the camera module 171, or the light module 172 on the basis of the sensing data received from the sensor module 161. In an embodiment, for example, the processor 110 may compare authentication data applied by the fingerprint sensor 161-1 with the authentication data stored in the memory 120, and then execute an application according to the comparison results. The processor 110 may execute a command or output corresponding image data to the display module 140, on the basis of the sensing data detected by the input sensor 161-2 or the digitizer 161-3. When a temperature sensor is included in the sensor module 161, the processor 110 may receive temperature data about a temperature measured from the sensor module 161 and further perform brightness correction and the like on the image data on the basis of the temperature data.

The processor 110 may receive measurement data about a user's presence/absence, a user's location, a user's gaze, and the like from the camera module 171. The processor 110 may further perform brightness correction and the like on the image data on the basis of the measurement data. In an embodiment, for example, the processor 110 may determine whether a user is present or not through an input from the camera module 171, and then output the brightness-corrected image data, to the display module 140, through the data conversion circuit 112-2 or the gamma correction circuit 112-3.

Some components among the above components may be connected to each other through a communication method between peripheral devices, for example, a bus, general purpose input/output (GPIO), a serial peripheral interface (SPI), a mobile industry processor interface (MIPI), or an ultra path interconnect (UPI) link, and may exchange signals (for example, a command or data) with each other. The processor 110 may communicate with the display module 140 through a mutually agreed-upon interface. For example, any one of the communication methods described above may be used, and an embodiment of the invention is not limited to the communication methods described above.

The electronic device 101 according to various embodiments disclosed in this specification may be a device having various forms. The electronic device 101 may include, for example, at least one selected from a mobile communication device (for example, a smartphone), a computer device, a mobile multimedia device, a mobile medical device, a camera, a wearable device, or a home appliance. The electronic device 101 according to the embodiment of this specification is not limited to devices described above.

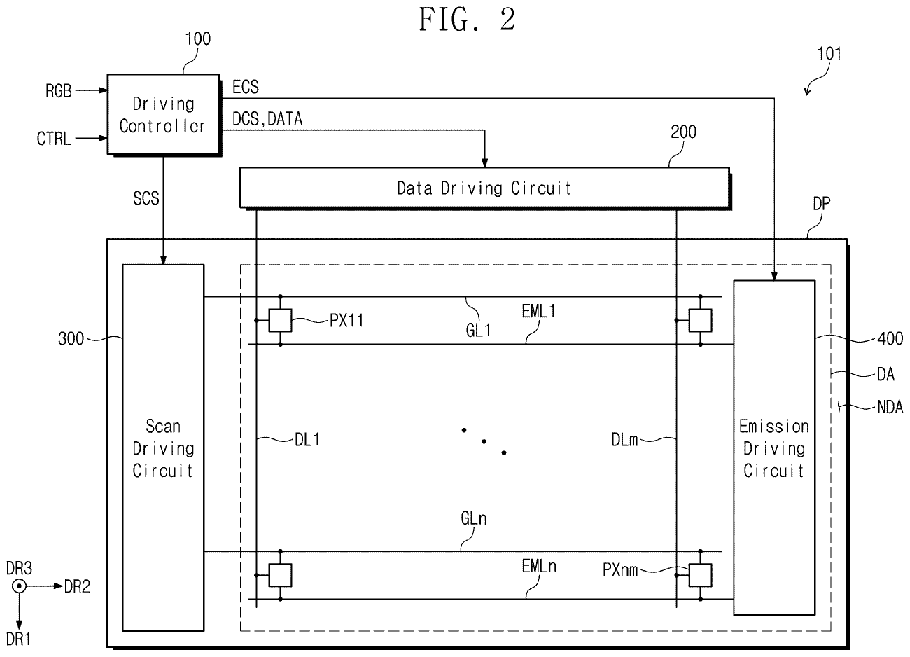

FIG. 2 is a block diagram of an electronic device 101 according to an embodiment of the invention.

Referring to FIG. 2, an embodiment of the electronic device 101 may include a driving controller 100, a data driving circuit 200, and a display panel DP.

The driving controller 100 may receive an input image signal RGB and a control signal CTRL. The driving controller 100 may generate an output image signal DATA obtained by converting the input image signal RGB to an image type suitable for the display panel DP. The driving controller 100 may output a scan control signal SCS and a data control signal DCS.

The display panel DP according to an embodiment of the invention may be a light-emitting display panel. In an embodiment, for example, the display panel DP may be an organic light-emitting display panel, an inorganic light-emitting display panel, or a quantum dot light-emitting display panel. A light-emitting layer of the organic light-emitting display panel may include an organic light-emitting material. A light-emitting layer of the inorganic light-emitting display panel may include an inorganic light-emitting material. A light-emitting layer of the quantum dot light-emitting display panel may include quantum dots, quantum rods, and the like. Hereinafter, for convenience of description, embodiments where the display panel DP is an organic light-emitting display panel will be mainly described.

The display panel DP may include a plurality of scan lines GL1-GLn, a plurality of data lines DL1-DLm, a plurality of emission control lines EML1-EMLn, and a plurality of pixels PX11-PXnm. Here, n may be an integer greater than or equal to 2, and m may be an integer greater than or equal to 2.

The display panel DP may include a display region DA and a non-display region NDA. In an embodiment, the display region DA has a quadrilateral shape, but the invention is not limited thereto. The non-display region NDA may have a frame shape surrounding the display region DA.

The display panel DP may further include a scan driving circuit 300 and an emission driving circuit 400. The pixels PX11-PXnm may be disposed in the display region DA, and the scan driving circuit 300 and the emission driving circuit 400 may be disposed in the non-display region NDA. However, an embodiment of the invention is not limited thereto, and the scan driving circuit 300 and the emission driving circuit 400 may be disposed in the display region DA.

The scan lines GL1-GLn may be arranged spaced apart from each other in a first direction DR1, and the scan lines GL1-GLn may each extend in a second direction DR2 from the scan driving circuit 300. The emission control lines EML1-EMLn may be arranged spaced apart from each other in the first direction DR1, and the emission control lines EML1-EMLn may each extend in an opposite direction of the second direction DR2 from the emission driving circuit 400. The data lines DL1-DLm may extend in the first direction DR1 from the data driving circuit 200 and may be arranged spaced apart from each other in the second direction DR2.

Each of the pixels PX11-PXnm may be connected to a corresponding scan line among the scan lines GL1-GLn, to a corresponding data line among the data lines DL1-DLm, and to an emission control line among the emission control lines EML1-EMLn. FIG. 2 illustrates that the pixels PX11-PXnm are each connected to one scan line, but the invention is not limited thereto. The pixels PX11-PXnm may each be electrically connected to two or more scan lines.

Each of the pixels PX11-PXnm may include a light-emitting element and a pixel circuit for controlling the light emission of the light-emitting element. The light-emitting element and the pixel circuit will be described in detail later.

The data driving circuit 200 may receive the data control signal DCS and the output image signal DATA from the driving controller 100. The data driving circuit 200 may convert the output image signal DATA to data signals, and output the data signals to the data lines DL1-DLm. Each of the data signals may have a voltage level corresponding to a gradation level of the output image signal DATA. Thus, the data driving circuit 200 may output corresponding data voltages to the respective data lines DL1-DLm.

In an embodiment, the data driving circuit 200 may be implemented as an integrated circuit (IC) and directly mounted in a predetermined region of the display panel DP, or may be mounted on a separate printed circuit board in a chip-on-film (COF) manner to be electrically connected to the display panel DP. In an embodiment, the data driving circuit 200 and the pixel circuit of each of the pixels PX11-PXnm may be formed through a same process on the display panel DP.

The scan driving circuit 300 may receive the scan control signal SCS from the driving controller 100. The scan driving circuit 300 may output scan signals to the scan lines GL1-GLn in response to the scan control signal SCS. In an embodiment, the scan driving circuit 300 and the pixel circuit of each of the pixels PX11-PXnm may be formed through the same process.

The emission driving circuit 400 may receive an emission driving signal ECS from the driving controller 100. The emission driving circuit 400 may output emission control signals to the emission control lines EML1-EMLn in response to the emission driving signal ECS. In an embodiment, the emission driving circuit 400 and the pixel circuit of each of the pixels PX11-PXnm may be formed through a same process.

The driving controller 100, the data driving circuit 200, the scan driving circuit 300, and the emission driving circuit 400 may be a driving circuit for providing a data signal, which correspond to the input image signal RGB, to the pixels PX11-PXnm.

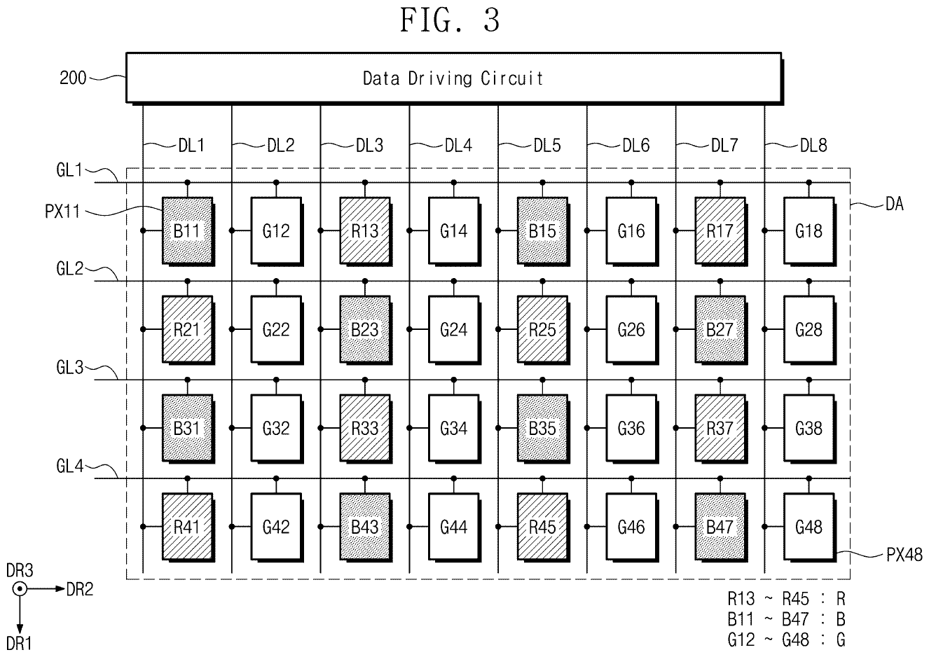

FIG. 3 is a view illustrating an arrangement of pixels PX11-PX48 according to an embodiment of the invention.

Referring to FIG. 3, in an embodiment, the display panel DP may include the pixels PX11-PX48, data lines DL1-DL8, and scan lines GL1-GL4. FIG. 3 illustrates some of the pixels PX11-PXnm (see FIG. 2), for example, 32 pixels PX11-PX48. In addition, eight data lines DL1-DL8 and four scan lines GL1-GL4 electrically connected to the 32 pixels PX11-PX48 are illustrated in FIG. 3.

The pixels PX11-PX48 may include a plurality of first pixels R13, R17, R21, R25, R33, R37, R41, and R45, a plurality of second pixels B11, B15, B23, B27, B31, B35, B43, and B47, and a plurality of third pixels G12, G14, G16, G18, G22, G24, G26, G28, G32, G34, G36, G38, G42, G44, G46, and G48. Hereinafter, the first pixels R13, R17, R21, R25, R33, R37, R41, and R45 may be referred to as first pixels R, the second pixels B11, B15, B23, B27, B31, B35, B43, and B47 as second pixels B, and the third pixels G12, G14, G16, G18, G22, G24, G26, G28, G32, G34, G36, G38, G42, G44, G46, and G48 as third pixels G.

In an embodiment of the invention, the first pixels R may be red pixels, the second pixels B may be blue pixels, and the third pixels G may be green pixels. However, the invention is not limited thereto, and the first pixels R, the second pixels B, and the third pixels G may include pixels of various colors such as yellow, cyan, magenta, white, and the like.

In an embodiment of the invention, the first pixels R, the second pixels B, and the third pixels G may be respectively connected to corresponding scan lines among the scan lines GL1-GL4. In an embodiment, for example, the pixels B11, G12, R13, G14, B15, G16, R17, and G18 arranged in the first row, among the first pixels R, the second pixels B, and the third pixels G, may be connected to a first scan line GL1, and the pixels R21, G22, B23, G24, R25, G26, B27, and G28 arranged in the second row may be connected to a second scan line GL2.

In an embodiment of the invention, the first pixels R and the second pixels B may be arranged one by one repetitively and alternately along the first direction DR1. In an embodiment, for example, the pixels B11, R21, B31, and R41 arranged in the first column may be arranged in order of the second pixel B11, the first pixel R21, the second pixel B31, and the first pixel R41, and the pixels R13, B23, R33, and B43 arranged in the third column may be arranged in order of the first pixel R13, the second pixel B23, the first pixel R33, and the second pixel B43.

In an embodiment of the invention, the third pixels G may be arranged successively along the first direction DR1. The third pixels G may be arranged spaced apart from each other in the second direction DR2 with the first pixels R and the second pixels B therebetween. In an embodiment, for example, the third pixels G may be arranged in even columns, and the first pixels R and the second pixels B may be arranged in odd columns.

In an embodiment of the invention, the first pixels R, the second pixels B, and the third pixels G may be respectively connected to corresponding data lines among the data lines DL1-DL8. In an embodiment, for example, the pixels B11, R21, B31, and R41 arranged in the first column may be connected to the first data line DL1, and the pixels G12, G22, G32, and G42 arranged in the second column may be connected to the second data line DL2, and the pixels R13, B23, R33, and B43 arranged in the third column may be connected to the third data line DL3.

In an embodiment, as described above, where the first pixels R and the second pixels B are arranged one by one repetitively and alternately, data voltages respectively transferred to the first pixel R and the second pixel B may be consecutive. Here, the data voltage may have a data peak caused by switching. In an embodiment, for example, when switching, the data voltages may be superposed, resulting in overshoot or undershoot. According to embodiments of the invention, the data driving circuit 200 (see FIG. 2) may be designed in a way such that the data peak is reduced, or does not occur. Hereinafter, the data driving circuit 200 (see FIG. 2) will be described in detail.

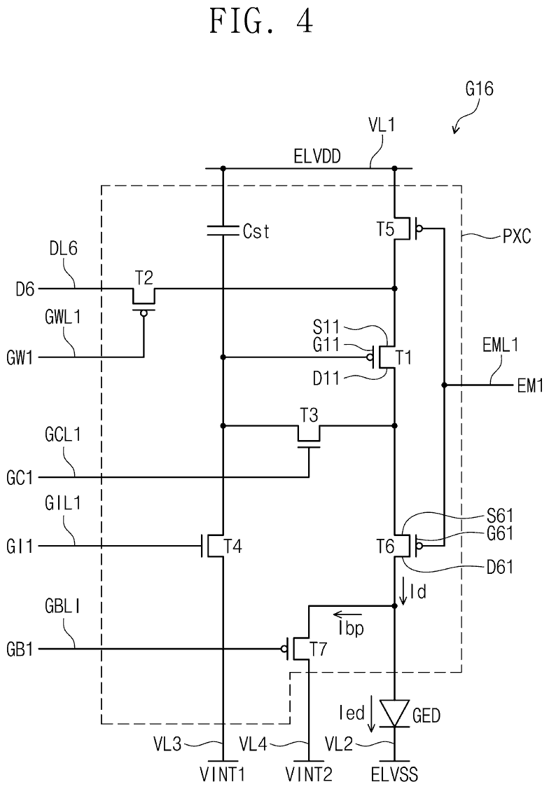

FIG. 4 is a circuit diagram of a pixel G16 according to an embodiment of the invention.

FIG. 4 illustrates an equivalent circuit diagram of a third pixel G16, among the pixels PX11-PX48 illustrated in FIG. 3, which is connected to a sixth data line DL6, first scan lines GWL1, GCL1, GIL1, and GBL1, and a first emission control line EML1. Hereinafter, the third pixel G16 may be referred to as a pixel G16.

Referring to FIGS. 3 and 4, the pixels PX11-PX48 illustrated in FIG. 3 may each have a circuit configuration that is the same as the equivalent circuit diagram of the pixel G16 illustrated in FIG. 4. In an embodiment, a pixel circuit PXC of the pixel G16 may include first to seventh transistors T1, T2, T3, T4, T5, T6, and T7, a capacitor Cst, and at least one light-emitting element GED. In this embodiment, the light-emitting element GED may be a light-emitting diode. Since FIG. 4 illustrates the third pixel G16, the light-emitting element GED may emit green light. In an embodiment of the invention, unlike FIG. 4, a light-emitting element of the first pixel may emit red light, and a light-emitting element of the second pixel may emit blue light.

The third and fourth transistors T3 and T4 among the first to seventh transistors T1, T2, T3, T4, T5, T6, and T7 may each be an N-type transistor having an oxide semiconductor as a semiconductor layer, and the first, second, fifth, sixth, and seventh transistors T1, T2, T5, T6, and T7 may each be a P-type transistor having low-temperature polycrystalline silicon (LTPS) as a semiconductor layer. However, the invention is not limited thereto, and the first to seventh transistors T1, T2, T3, T4, T5, T6, and T7 may all be a P-type transistor or an N-type transistor. In another embodiment, at least one selected from the first to seventh transistors T1, T2, T3, T4, T5, T6, and T7 may be an N-type transistor, and the rest may be a P-type transistor.

In an embodiment of the invention, the pixel circuit PXC may be electrically connected to one data line DL6, four scan lines GIL1, GCL1, GWL1, and GBL1, and one emission control line EML1.

The scan lines GIL1, GCL1, GWL1, and GBL1 may transfer scan signals GI1, GC1, GW1, and GB1 respectively, and the emission control line EML1 may transfer an emission control signal EM1. The data line DL6 may transfer a data signal D6. The data signal D6 may have a voltage level corresponding to the image signal RGB (see FIG. 2) input to the electronic device 101 (see FIG. 2).

First to fourth driving voltage lines VL1, VL2, VL3, and VL4 may transfer a first driving voltage ELVDD, a second driving voltage ELVSS, a first initialization voltage VINT1, and a second initialization voltage VINT2.

The first transistor T1 may include a first electrode S11 connected to the first driving voltage line VL1 via the fifth transistor T5, a second electrode D11 electrically connected to an anode of the light-emitting element GED via the sixth transistor T6, and a gate electrode G11 connected to one end of the capacitor Cst. The first transistor T1 may receive the data signal D6 transferred by the data line DL6 in accordance with a switching operation of the second transistor T2, and supply driving current Id to the light-emitting element GED.

The second transistor T2 may include a first electrode connected to the data line DL6, a second electrode connected to the first electrode S11 of the first transistor T1, and a gate electrode connected to the scan line GWL1. The second transistor T2 may be turned on in response to the scan signal GW1 transferred via the scan line GWL1, and may transfer, to the first electrode S11 of the first transistor T1, the data signal D6 transferred from the data line DL6.

The third transistor T3 may include a first electrode connected to the gate electrode G11 of the first transistor T1, a second electrode connected to the second electrode D11 of the first transistor T1, and a gate electrode connected to the scan line GCL1. The third transistor T3 may be turned on in response to the scan signal GC1 transferred via the scan line GCL1, connect the gate electrode G11 of the first transistor T1 and the second electrode D11 of the first transistor T1 to each other, and thereby diode-connect the first transistor T1.

The fourth transistor T4 may include a first electrode connected to the gate electrode G11 of the first transistor T1, a second electrode connected to the third driving voltage line VL3 to which the first initialization voltage VINT1 is transferred, and a gate electrode connected to the scan line GIL1. The fourth transistor T4 may be turned on in response to the scan signal GI1 transferred via the scan line GIL1, transfer the first initialization voltage VINT1 to the gate electrode G11 of the first transistor T1, and thereby perform initialization operation for initializing the voltage of the gate electrode G11 of the first transistor T1.

The fifth transistor T5 may include a first electrode connected to the first driving voltage line VL1, a second electrode connected to the first electrode S11 of the first transistor T1, and a gate electrode connected to the emission control line EML1.

The sixth transistor T6 may include a first electrode S61 connected to the second electrode D11 of the first transistor T1, a second electrode D61 connected to an anode of the light-emitting element GED, and a gate electrode G61 connected to the emission control line EML1.

The fifth transistor T5 and the sixth transistor T6 may be turned on simultaneously in response to the emission control signal EM1 transferred via the emission control line EML1, and the first driving voltage ELVDD may be compensated by the diode-connected first transistor T1 and transferred to the light-emitting element GED.

The seventh transistor T7 may include a first electrode connected to the second electrode of the sixth transistor T6, a second electrode connected to the fourth driving voltage line VL4, and a gate electrode connected to the scan line GBL1. The seventh transistor T7 may be turned on in response to the scan signal GB1 transferred via the scan line GBL1, and bypass the current of the anode of the light-emitting element GED to the fourth driving voltage line VL4.

In an embodiment, as described above, the one end of the capacitor Cst may be connected to the gate electrode G11 of the first transistor T1 and the other end may be connected to the first driving voltage line VL1.

An anode of the light-emitting element GED may be connected to the second electrode D61 of the sixth transistor T6, and a cathode thereof may be connected to the second driving voltage line VL2 which transfers the second driving voltage ELVSS.

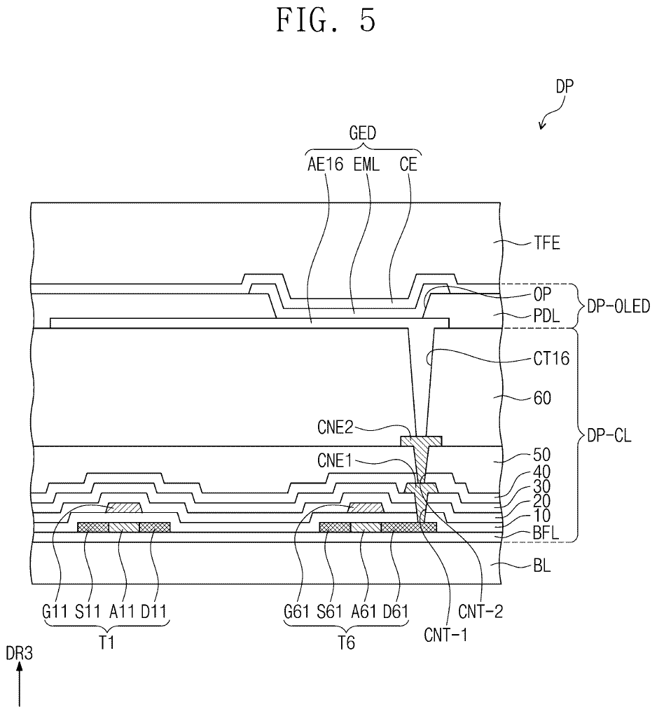

FIG. 5 is a cross-sectional view of a display panel DP according to an embodiment of the invention.

FIG. 5 schematically illustrates a cross-section of a portion corresponding to the first transistor T1 and the sixth transistor T6 of the pixel G16 illustrated in FIG. 4.

Referring to FIG. 5, in an embodiment, the display panel DP may include a base layer BL, and a circuit element layer DP-CL, a display element layer DP-OLED, and a thin-film encapsulation layer TFE which are disposed on the base layer BL.

The display panel DP may further include functional layers such as a refractive index adjustment layer. The circuit element layer DP-CL may include at least a plurality of insulation layers and a circuit element. Hereinafter, the insulation layers may include an organic layer and/or an inorganic layer.

An insulation layer, a semiconductor layer, and a conductive layer may be formed through a process such as coating, depositing, and the like. Thereafter, the insulation layer, the semiconductor layer, and the conductive layer may be patterned selectively through photolithography and etching processes. A semiconductor pattern, a conductive pattern, a signal line, and the like may be formed through such processes. Patterns disposed at a same layer may be patterns formed through a same process.

The base layer BL may include a synthetic resin layer. The synthetic resin layer may include a thermosetting resin. In an embodiment, for example, the synthetic resin layer may be a polyimide-based resin layer, and the material is not particularly limited. The synthetic resin layer may include at least one selected from an acrylate-based resin, a methacrylate-based resin, polyisoprene, a vinyl-based resin, an epoxy-based resin, a urethane-based resin, a cellulose-based resin, a siloxane-based resin, a polyamide-based resin, or a perylene-based resin. In addition, the base layer may include a glass substrate, a metal substrate, an organic/inorganic composite material layer, or the like.

At least one inorganic layer may be formed on an upper surface of the base layer BL. The inorganic layer may include at least one selected from aluminum oxide, titanium oxide, silicon oxide, silicon oxynitride, zirconium oxide, or hafnium oxide. The inorganic layer may be formed as a multilayer. At least one selected from the multi-layered inorganic layers may constitute a buffer layer BFL.

The buffer layer BFL may improve a bonding force between the base layer BL and the semiconductor pattern and/or the conductive pattern. The buffer layer BFL may include a silicon oxide layer and a silicon nitride layer. The silicon oxide layer and the silicon nitride layer may be stacked alternately.

First semiconductor patterns S11, A11, and D11 and second semiconductor patterns S61, A61, and D61 may be disposed on the buffer layer BFL. The first semiconductor patterns S11, A11, and D11 and the second semiconductor patterns S61, A61, and D61 may be directly disposed on the buffer layer BFL. The first semiconductor patterns S11, A11, and D11 and the second semiconductor patterns

S61, A61, and D61 may include a silicon semiconductor. In an embodiment, for example, the silicon semiconductor may include amorphous silicon, polysilicon silicon, and the like. In an embodiment, for example, the first semiconductor patterns S11, A11, and D11 and the second semiconductor patterns S61, A61, and D61 may include low-temperature polycrystalline silicon (LTPS).

The first semiconductor patterns S11, A11, and D11 and the second semiconductor patterns S61, A61, and D61 may have different electrical properties depending on whether to be doped or not. The first semiconductor patterns S11, A11, and D11 and the second semiconductor patterns S61, A61, and D61 may include a doped region and an undoped region. The doped region may be doped with an N-type dopant or a P-type dopant. A P-type transistor may include a doped region doped with a P-type dopant.

The doped region has greater conductivity than the undoped region, and may substantially serve as an electrode or a signal line. The undoped region may substantially be an active (or a channel) of a transistor. In other words, a portion of the first semiconductor patterns S11, A11, and D11 and the second semiconductor patterns S61, A61, and D61 may be an active of a transistor, another portion may be a first electrode (a source electrode) or a second electrode (a drain electrode) of a transistor, and still another potion may be a connection electrode or a connection signal line (or a connection electrode).

As illustrated in FIG. 5, the first electrode S11, the active A11, and the second electrode D11 of the first transistor T1 may be formed from (or defined by) the first semiconductor patterns S11, A11, and D11. The first electrode S11 and the second electrode D11 of the first transistor T1 may extend in opposite directions from the active A11. In addition, the first electrode S61, the active A61, and the second electrode D61 of the sixth transistor T6 may be formed from the second semiconductor patterns S61, A61, and D61. The first electrode S61 and the second electrode D61 of the sixth transistor T6 may extend in opposite directions from the active A61.

Although not illustrated separately in FIG. 5, with reference to FIG. 4, the first electrode S61 of the sixth transistor T6 may be electrically connected to the second electrode D11 of the first transistor T1.

A first insulation layer 10 may be disposed on the buffer layer BFL. The first insulation layer 10 may overlap a plurality of pixels in common, and may cover the first conductor patterns S11, A11, and D11. The first insulation layer 10 may be an inorganic and/or an organic layer, and have a single-layered or multi-layered structure. The first insulation layer 10 may include at least one selected from aluminum oxide, titanium oxide, silicon oxide, silicon oxynitride, zirconium oxide, or hafnium oxide. In this embodiment, the first insulation layer 10 may be a single-layered silicon oxynitride layer. Not only the first insulation layer 10, but an insulation layer of the circuit element layer DP-CL, which is to be described later, may be an inorganic and/or organic layer, and may have a single-layered or multi-layered structure. The inorganic layer may include at least one selected from the aforementioned materials.

The gate electrode G11 of the first transistor T1 may be disposed on the first insulation layer 10. The gate electrode G11 may be a portion of the metal pattern. The gate electrode G11 of the first transistor T1 may overlap the active A11 of the first transistor T1. The gate electrode G11 of the first transistor T1 may function as a mask in a process for doping the first semiconductor patterns S11, A11, and D11. The gate electrode G11 may include at least one selected from titanium (Ti), silver (Ag), a Ag-containing alloy, molybdenum (Mo), a Mg-containing alloy, aluminum (Al), an Al-containing alloy, aluminum nitride (AlN), tungsten (W), tungsten nitride (WN), copper (Cu), indium tin oxide (ITO), indium zinc oxide (IZO), and the like, but is not particularly limited thereto.

A second insulation layer 20 may be disposed on the first insulation layer 10 and cover the gate electrode G11 of the first transistor T1. The second insulation layer 20 may be an inorganic layer and/or an organic layer, and have a single-layered or multi-layered structure. The second insulation layer 20 may include at least one selected from silicon oxide, silicon nitride, or silicon oxynitride. In this embodiment, the second insulation layer 20 may have a multi-layered structure including a silicon oxide layer and a silicon nitride layer.

A third insulation layer 30 may be disposed on the second insulation layer 20. The third insulation layer 30 may have a single-layered or multi-layered structure. In an embodiment, for example, the third insulation layer 30 may have a multi-layered structure including a silicon oxide layer and a silicon nitride layer.

A first connection electrode CNE1 may be disposed on the third insulation layer 30. The first connection electrode CNE1 may be in contact with the second electrode D61 of the sixth transistor T6 through a first contact hole CNT-1 which penetrates (or is defined or formed through) the first to third insulation layers 10 to 30.

A fourth insulation layer 40 may be disposed on the third insulation layer 30 and cover the first connection electrode CNE1. The fourth insulation layer 40 may include at least one selected from aluminum oxide, titanium oxide, silicon oxide, silicon nitride, silicon oxynitride, zirconium oxide, or hafnium oxide.

A fifth insulation layer 50 may be disposed on the fourth insulation layer 40. The fifth insulation layer 50 may be an organic layer.

A second connection electrode CNE2 may be disposed on the fifth insulation layer 50. The second connection electrode CNE2 may be in contact with the first connection electrode CNE1 through a second contact hole CNT-2 which penetrates the fourth insulation layer 40 and the fifth insulation layer 50.

A sixth insulation layer 60 may be disposed on the fifth insulation layer 50 and cover the second connection electrode CNE2. The sixth insulation layer 60 may be an organic layer.

The display element layer DP-OLED may be disposed on the circuit element layer DP-CL. The display element layer DP-OLED may include the light-emitting elements GED. FIG. 5 illustrates one light-emitting element GED. The light-emitting element GED may include an anode AE16, an emission layer EML, and a cathode CE.

The anode AE16 of the light-emitting element GED may be disposed on the sixth insulation layer 60. The anode AE16 may be connected to the second connection electrode CNE2 through a connection node CT16 which penetrates the sixth insulation layer 60. A pixel-defining film PDL may be provided with an opening OP defined therein. The opening OP of the pixel-defining film PDL may expose at least a portion of the anode AE16.

The emission layer EML may be disposed on the anode AE16. The emission layer EML may be disposed only in a region corresponding to the opening OP. The emission layer EML may be formed separately in each of the plurality of pixels PX11-PXnm (see FIG. 2).

In this embodiment, the patterned emission layer EML is illustrated, but the emission layer EML may be disposed in the pixels PX11-PXnm (see FIG. 2) in common. Here, the emission layer EML may generate white light or blue light. In addition, the emission layer EML may have a multi-layered structure.

The cathode CE may be disposed on the emission layer EML. The cathode CE may be disposed in the pixels PX11-PXnm (see FIG. 2) in common.

Although not illustrated in the drawing, a hole control layer may be disposed between the anode AE16 and the emission layer EML. In addition, an electron control layer may be disposed between the emission layer EML and the cathode CE. In an embodiment of the invention, the display element layer DP-OLED may further include a capping layer which directly covers the cathode CE.

The thin-film encapsulation layer TFE may be disposed on the display element layer DP-OLED.

The thin-film encapsulation layer TFE may be disposed on the cathode CE. The thin-film encapsulation layer TFE may be disposed in the pixels PX11-PXnm (see FIG. 2) in common. In an embodiment, the thin-film encapsulation layer TFE may directly cover the cathode CE.

The thin-film encapsulation layer TFE may include at least an inorganic layer or an organic layer. In an embodiment of the invention, the thin-film encapsulation layer TFE may include two inorganic layers and an organic layer disposed therebetween. In an embodiment of the invention, the thin-film encapsulation layer TFE may include a plurality of inorganic layers and a plurality of organic layers which are stacked alternately.

An inorganic encapsulation layer may protect the light-emitting element GED from moisture/oxygen, and an organic encapsulation layer may protect the light-emitting element GED from foreign matter such as dust particles. The inorganic encapsulation layer may include at least one selected from a silicon nitride layer, a silicon oxynitride layer, a silicon oxide layer, a titanium oxide layer, an aluminum oxide layer, or the like, and is not particularly limited thereto. The organic encapsulation layer may include an acrylate-based organic layer and is not particularly limited thereto.

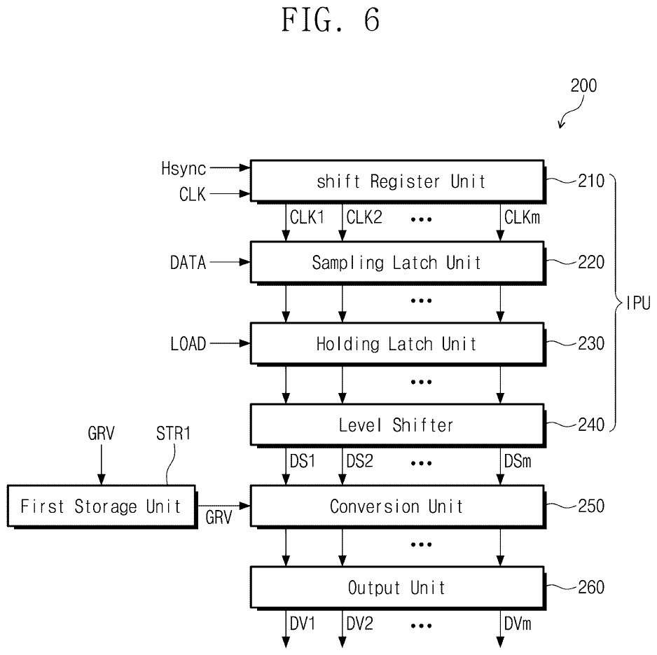

FIG. 6 is a block diagram of a data driving circuit 200 according to an embodiment of the invention.

Referring to FIGS. 2 and 6, an embodiment of the data driving circuit 200 may include an input unit IPU, a first storage unit STR1, a conversion unit 250, and an output unit 260.

In an embodiment of the invention, the input unit IPU may include a shift register unit 210, a sampling latch unit 220, a holding latch unit 230, and a level shifter 240.

The shift register unit 210 may receive a horizontal synchronization signal Hsync and an initiation clock signal CLK from a driving controller 100. Here, the horizontal synchronization signal Hsync and the initiation clock signal CLK may be included in a data control signal DCS.

The shift register unit 210 may output a plurality of clock signals CLK1-CLKm sequentially. In an embodiment, for example, the shift register unit 210 may shift the horizontal synchronization signal Hsync in response to the initiation clock signal CLK, and output clock signals CLK1-CLKm sequentially in accordance with the shifted horizontal synchronization signal Hsync. Thus, the shift register unit 210 may include a plurality of shift registers.

The sampling latch unit 220 may receive the clock signals CLK1-CLKm from the shift register unit 210 and receive a plurality of data DATA from the driving controller 100. In such an embodiment, the data DATA may correspond to the output image signal DATA illustrated in FIG. 2.

The sampling latch unit 220 may store the data DATA sequentially in response to the clock signals CLK1-CLKm. Thus, the sampling latch unit 220 may include a plurality of sampling latches. In addition, the sampling latch unit 220 may output the stored data DATA corresponding to the data lines DL1-DLm, respectively.

The holding latch unit 230 may receive the data DATA from the sampling latch unit 220 and receive a load signal LOAD from the driving controller 100. Here, the holding latch unit 230 may receive the data DATA stored in the sampling latch unit 220 simultaneously. The holding latch unit 230 may store the data DATA. In addition, the holding latch unit 230 may output the stored data DATA to the level shifter 240 in response to the load signal LOAD. Therefore, the holding latch unit 230 may include a plurality of holding latches capable of storing the data DATA.

The level shifter 240 may receive the data DATA from the holding latch unit 230. The level shifter 240 may change a voltage level of the data DATA. In an embodiment, for example, the level shifter 240 may change a voltage level of the data DATA received from the holding latch unit 230 to a voltage level corresponding to the conversion unit 250. Thus, the level shifter 240 may output the received data DATA as data signals DS1-DSm.

An embodiment of the input unit IPU including all of the shift register unit 210, the sampling latch unit 220, the holding latch unit 230, and the level shifter 240 is illustrated in FIG. 6, but at least some among the shift register unit 210, the sampling latch unit 220, the holding latch unit 230, and the level shifter 240 may be omitted in another embodiment.

The first storage unit STR1 may receive a gamma reference value GRV from the driving controller 100, and store the gamma reference value GRV. The gamma reference value GRV may be referred to as a gamma reference voltage GRV. The first storage unit STR1 may output the stored gamma reference value GRV to the conversion unit 250.

In an embodiment of the invention, the gamma reference value GRV may vary depending on the red pixels, green pixels, and blue pixels. Therefore, as the data voltage provided to the first pixels R and the data voltage provided to the second pixels B, which are illustrated in FIG. 2 are switched consecutively, consecutively different gamma reference values GRV may be used. In such an embodiment where different gamma reference values GRV are used, a data peak of the data voltage may occur. According to an embodiment of the invention, however, the data driving circuit 200 may be designed to control the timing of the data voltages to be different from each other so that the data peak is reduced, or does not occur.

In an embodiment of the invention, the gamma reference value GRV may be the same in all of the red pixels, green pixels, and blue pixels. Therefore, even when the data voltage provided to the first pixels R and the data voltage provided to the second pixels B, which are illustrated in FIG. 2, are switched consecutively, the same gamma reference value GRV may be used. In such an embodiment where the same gamma reference value GRV is used, the section where the data voltages are superposed may be reduced and the data peak due to superposition may be reduced, or may not occur.

The conversion unit 250 may receive the data signals DS1-DSm from the level shifter 240 and receive the gamma reference value GRV from the first storage unit STR1. The conversion unit 250 may convert the data signals DS1-DSm and output data voltages DV1-DVm corresponding to the data lines DL1-DLm, respectively. Here, the gamma reference value GRV may be used when converting the data signals DS1-DSm to the data voltages DV1-DVm. Therefore, the conversion unit 250 may be referred to as a digital-analog conversion unit 250, and may include a digital-analog converter (DAC).

The output unit 260 may receive the data voltages DV1-DVm from the conversion unit 250 and output the data voltages to corresponding data lines DL1-DLm, respectively. The output unit 260 may be included in the conversion unit 250 and the data voltages DV1-DVm may be output from the conversion unit 250 to corresponding data lines DL1-DLM, respectively.

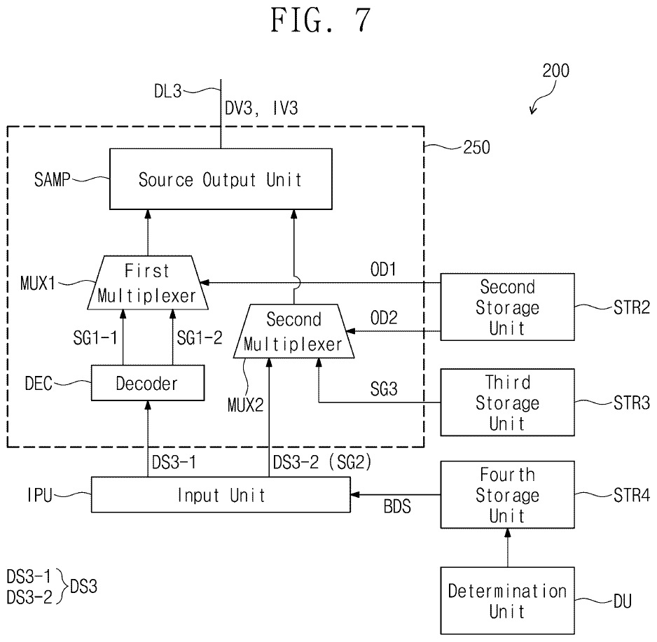

FIG. 7 is a block diagram illustrating a portion of a data driving circuit 200 according to an embodiment of the invention.

FIG. 7 illustrates that a data voltage DV3 is output to one data line DL3. More specifically, one data line DL3 electrically connected to the pixels R13, B23, R33, and B43, which are arranged in the third column as illustrated in FIG. 3, and the data voltage DV3 are illustrated. Hereinafter, the pixels R13, B23, R33, and B43 arranged in the third column may be referred to as a third column pixels R13, B23, R33, and B43.

Among components illustrated in FIG. 7, the components that are the same as the components illustrated in FIG. 6 will be denoted with the same reference numerals or symbols, and any repetitive detailed description thereof will be omitted.

Referring to FIGS. 3, 6, and 7, an embodiment of the data driving circuit 200 may include an input unit IPU, a conversion unit 250, a second storage unit STR2, a third storage unit STR3, a fourth storage unit STR4, and a determination unit DU.

The input unit IPU may output a data signal DS3 to the conversion unit 250. In an embodiment of the invention, the data signal DS3 may include a first data signal DS3-1 and a second data signal DS3-2. The data signal DS3 may be composed of a plurality of bits. In an embodiment, for example, the data signal DS3 may include z bit data. Here, z may be an integer greater than or equal to 1.

In an embodiment of the invention, the first data signal DS3-1 may include x upper bit data among the plurality of bits of the data signal DS3. The second data signal DS3-2 may include y lower bit data among the plurality of bits of the data signal DS3. Here, x may be an integer between 0 and z (i.e., greater than 0 and less than z). Here, y may be an integer between 0 and z.

In an embodiment of the invention, the determination unit DU may determine an x value of the x upper bit data and a y value of the y lower bit data. A plurality of x values and a plurality of y values may be stored in the fourth storage unit STR4. In an embodiment, for example, z may be 10, the determination unit DU may determine that the first data signal DS3-1 is configured to have 6 bits and the second data signal DS3-2 is configured to have 4 bits. The determination unit DU may transfer signals for the determined x value and y value to the fourth storage unit STR4. Thus, the input unit IPU may receive, in response to a signal received from the determination unit DU, a signal BDS which includes corresponding x value and y value, among the x values and y values stored in the fourth storage unit STR4. The signal BDS may be referred to as a bit determination signal BDS or a bit control signal BDS, and the fourth storage unit STR4 may be referred to as a memory STR4.

When the driving controller 100 (see FIG. 1) receives a control signal from the processor 110 (see FIG. 1), the fourth storage unit STR4 may immediately read corresponding x value and y value among the stored x values and y values, and output a signal, which includes corresponding x value and y value, as a bit determination signal BDS to the input unit IPU. The input unit IPU may transfer upper bit data and lower bit data determined by the bit determination signal BDS to the conversion unit 250 which converts data to apply the data to the display panel DP (see FIG. 1). FIG. 7 illustrates as an embodiment where the fourth storage unit STR4 is included in the data driving circuit 200, but an embodiment of the invention is not particularly limited thereto. In another embodiment, for example, the fourth storage unit STR4 may be configured as a chip separate from the data driving circuit 200.

In an embodiment of the invention, the conversion unit 250 may include a decoder DEC, a first multiplexer MUX1, a second multiplexer MUX2, and a source output unit SAMP.

In an embodiment of the invention, the decoder DEC may receive the first data signal DS3-1 from the input unit IPU and receive a gamma reference value GRV from the first storage unit STR1. The decoder DEC may use the gamma reference value GRV to convert the first data signal DS3-1 to a first first signal (hereinafter, will be referred to as “(1-1)-th signal”) SG1-1 and a second first signal (hereinafter, will be referred to as “(1-2)-th signal”) SG1-2. In an embodiment, for example, the decoder may select a gamma reference value GRV on the basis of a gradation value included in the first data signal DS3-1, and output the (1-1)-th signal SG1-1 and the (1-2)-th signal SG1-2. Here, similarly to the first data signal DS3-1, the (1-1)-th signal SG1-1 and the (1-2)-th signal SG1-2 may include x upper bit data. In an embodiment, for example, when the first data signal DS3-1 has six bits, the (1-1)-th signal SG1-1 and the (1-2)-th signal SG1-2 may also have six bits. The decoder DEC may output the (1-1)-th signal SG1-1 and the (1-2)-th signal SG1-2 to the first multiplexer MUX1. The (1-1)-th signal SG1-1 and the (1-2)-th signal SG1-2 may be respectively referred to as a first signal SG1-1 and SG1-2.

In an embodiment of the invention, the first multiplexer MUX1 may receive the (1-1)-th signal SG1-1 and the (1-2)-th signal SG1-2 from the decoder DEC.

The first multiplexer MUX1 may include two input terminals. The (1-1)-th signal SG1-1 may be applied to one of the two input terminals of the first multiplexer MUX1, and the (1-2)-th signal SG1-2 may be applied to the other one of the two input terminals of the first multiplexer MUX1. In an embodiment, for example, the (1-1)-th signal SG1-1 corresponding to an N-th first pixel among the third column pixels R13, B23, R33, and B43 may be applied to one input terminal of the first multiplexer MUX1, and the (1-2)-th signal SG1-2 corresponding to an N-th second pixel among the third column pixels R13, B23, R33, and B43 may be applied to the other input terminal of the first multiplexer MUX1. In an embodiment, for example, when N is 2, the first pixel may be the 2nd first pixel R33, and the second pixel may be the 2nd second pixel B43 in succession to the 2nd first pixel R33 in the first direction DR1. The first multiplexer MUX1 may select and output the (1-1)-th signal SG1-1 or the (1-2)-th signal SG1-2 applied to one of the two input terminals.

In an embodiment of the invention, the second multiplexer MUX2 may receive the second data signal DS3-2 directly from the input unit IPU, and receive a third signal SG3 from the third storage unit STR3. The third signal SG3 may be a signal for data interpolation, and may include y interpolation bit data. Therefore, a bit number of the third signal SG3 and a bit number of the second data signal DS3-2 may be the same as each other. Hereinafter, the second data signal DS3-2 may be referred to as a second signal SG2.

The second multiplexer MUX2 may include two input terminals. The second signal SG2 may be applied to one input terminal of the second multiplexer MUX2, and the third signal SG3 may be input to the other input terminal of the second multiplexer MUX2. In an embodiment, for example, the second signal SG2 corresponding to the N-th first pixel may be applied to one input terminal of the second multiplexer MUX2, and the third signal SG3, which is not previous data but separately received from the third storage unit STR3, may be applied to the other input terminal of the second multiplexer MUX2. The second multiplexer MUX2 may select and output the second signal SG2 or the third signal SG3 applied to one of the two input terminals.

An output timing of the (1-1)-th signal SG1-1 or the (1-2)-th signal SG1-2 which is output from the first multiplexer MUX1, and an output timing of the second signal SG2 or the third signal SG3 which is output from the second multiplexer MUX2, may be individually or respectively controlled by a timing control signal received from the second storage unit STR2. The timing control signal may include information about the output timing of the (1-1)-th signal SG1-1 or the (1-2)-th signal SG1-2, which is output from the first multiplexer MUX1, and information about the output timing of the second signal SG2 or the third signal SG3, which is output from the second multiplexer MUX2. Hereinafter, the information about the output timing will be described in detail with reference to a first output delay value OD1 and a second output delay value OD2.

In an embodiment of the invention, the third storage unit STR3 may be a one time programmable (OTP) register. However, an embodiment of the invention is not limited thereto, and the third storage unit STR3 may be a register having another non-volatile memory.

In an embodiment of the invention, the first output delay value OD1 of the (1-1)-th signal SG1-1 or the (1-2)-th signal SG1-2, which is output from the first multiplexer MUX1, and the second output delay value OD2 of the second signal SG2 or the third signal SG3, which is output from the second multiplexer MUX2, may be stored in the second storage unit STR2. The first output delay value OD1 and the second output delay value OD2 may each be a value delayed from a level change point of the horizontal synchronization signal Hsync. The second storage unit STR2 may output the first output delay value OD1 to the first multiplexer MUX1, and output the second output delay value OD2 to the second multiplexer MUX2.

In an embodiment of the invention, the source output unit SAMP may include a digital-analog converter and an amplifier. The source output unit SAMP may receive the (1-1)-th signal SG1-1 from the first multiplexer MUX1, and receive the second signal SG2 from the second multiplexer MUX2. The source output unit SAMP may include two input terminals. The source output unit SAMP may analog-convert and amplify the received (1-1)-th signal SG1-1 and the second signal SG2 to generate the data voltage DV3, and output the generated data voltage DV3 to the data line DL3. Therefore, the data voltage DV3 may be provided to a corresponding pixel connected to the data line DL3.

In an embodiment of the invention, the source output unit SAMP may further receive the third signal SG3 from the second multiplexer MUX2. The source output unit SAMP may analog-convert and amplify the received (1-1)-th signal SG1-1 and the third signal SG3 to further generate an interpolation data voltage IV3. The third signal SG3 may be interpolation data between the second signals SG2 which are provided to two adjacent pixels connected to one data line DL3. In an embodiment, for example, the third signal SG3 may have a value between the second signal SG2 of the 2nd first pixel R33 and the second signal SG2 of the 2nd second pixel B43 among the third column pixels R13, B23, R33, and B43. The interpolation data voltage IV3 may be output to the data line DL3, but may not be provided to a corresponding pixel connected to the data line DL3, for example, the first electrode S11 (see FIG. 4) of the first transistor T1 (see FIG. 4).

FIGS. 6 and 7 illustrate, as an example, an embodiment where the second storage unit STR2, the third storage unit STR3, the fourth storage unit STR4, and the determination unit DU are all included in the data driving circuit 200, but an embodiment of the invention is not particularly limited thereto. In another embodiment, for example, at least some among the second storage unit STR2, the third storage unit STR3, the fourth storage unit STR4, and the determination unit DU may be configured as a chip separate from the data driving circuit 200.

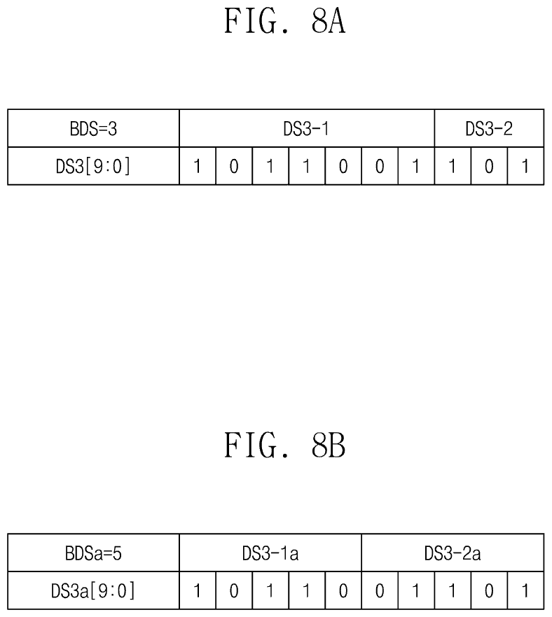

FIG. 8A is a table showing a bit number of each of a first data signal DS3-1 and a second data signal DS3-2 according to an embodiment of the invention. FIG. 8B is a table showing a bit number of each of a first data signal DS3-1a and a second data signal DS3-2a according to an embodiment of the invention. The first data signal DS3-1a may correspond to the (1-1)-th signal SG1-1 (see FIG. 7) and the (1-2)-th signal SG1-2 (see FIG. 7), and the second data signal DS3-2a may correspond to the second signal SG2 (see FIG. 7). The bit number of the third signal SG3 and the bit number of the second data signal DS3-2a may be the same.

Referring to FIGS. 7, 8A, and 8B, the fourth storage unit STR4 may output, to the input unit IPU, a signal, which includes corresponding x value and y value, among the x values and y values stored corresponding to the signal received from the determination unit DU, as a bit determination signal BDS.

Table 1 below shows y values stored in the fourth storage unit STR4 and the bit determination signal BDS output from the fourth storage unit STR4 as an example.

TABLE 1

| | Example in which the data signal | | |
|---|---|---|---|
| Fourth storage unit STR4 | DS3 has 10 bits (y value) | | |
| Bit determination signal BDS | 0 | 0 | bit |
| | 1 | 1 | bit |
| | 2 | 2 | bits |
| | 3 | 3 | bits |
| | 4 | 4 | bits |
| | 5 | 5 | bits |
| | . . . | | |
| | 10 | 10 | bits |

Referring to Table 1, a y value which is a bit number of the second data signal DS3-2 or the third signal SG3 may be stored in the fourth storage unit STR4. In addition, a corresponding y value among the y values stored in the fourth storage unit STR4 and an x value determined on the basis of the y value may be included in the bit determination signal BDS which is transferred to the input unit IPU from the fourth storage unit STR4. For example, since the data signal DS3 has 10 bits, the x value is 9 if the corresponding y value is 1, and the x value is 8 if the corresponding y value is 2. FIG. 8A illustrates the case where the bit determination signal BDS is 3, that is, the case where the y value of the second data signal DS3-2 is 3. In an embodiment of the invention, the second data signal DS3-2 may be configured to have 3 bits, and the first data signal DS3-1 may be configured to have 7 bits. Therefore, the first data signal DS3-1 may be 1011001, and the second data signal DS3-2 may be 101, for example.

FIG. 8B illustrates a case where a bit determination signal BDSa is 5, that is, the case where the y value of the second data signal DS3-2a is 5. In an embodiment of the invention, the second data signal DS3-2a may be configured to have 5 bits, and the first data signal DS3-1a may be configured to have 5 bits. Therefore, the first data signal DS3-1a may be 10110, and the second data signal DS3-2a may be 01101, for example.

FIGS. 8A and 8B illustrates the first data signals DS3-1 and DS3-1a, and the second data signals DS3-2 and DS3-2a. However, as described in FIG. 7, the bit number of the third signal SG3 and the bit number of the second data signals DS3-2 and DS3-2a are the same as each other, and therefore the third signal SG3 in FIG. 8A is configured to have 3 bits, and the third signal SG3 in FIG. 8B is configured to have 5 bits.

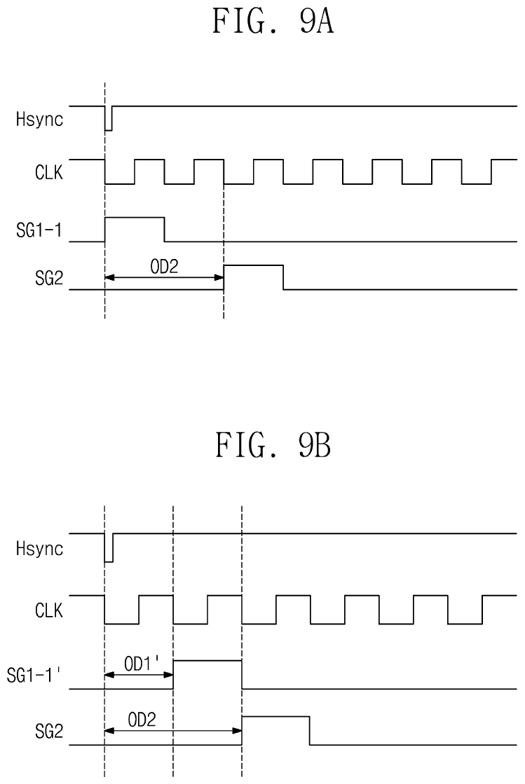

FIG. 9A is a signal timing diagram for describing a first output delay value OD1 and a second output delay value OD2 of signals according to an embodiment of the invention. FIG. 9B is a signal timing diagram for describing a first output delay value OD1′ and a second output delay value OD2 of signals according to an embodiment of the invention.

Referring to FIGS. 7, 9A, and 9B, the first output delay value OD1 of the (1-1)-th signal SG1-1 or the (1-2)-th signal SG1-2 which is output from the first multiplexer MUX1 and the second output delay value OD2 of the second signal SG2 or the third signal SG3, which is output from the second multiplexer MUX2, may be stored in the second storage unit STR2.

In an embodiment of the invention, the first output delay value OD1 and the second output delay value OD2 may each be a value delayed by a predetermined period of an initiation clock signal CLK from a level change point of a horizontal synchronization signal Hsync.

In an embodiment of the invention, the first output delay value OD1 and the second output delay value OD2 may be different from each other. That is, a p value corresponding to the first output delay value OD1 and a q value corresponding to the second output delay value OD2 may be different from each other. The p value and the q value may each correspond to a predetermined period. The p and q may each be an integer greater than or equal to 0.

Table 2 below shows delay values stored in the second storage unit STR2 and the first output delay value OD1 and the second output delay value OD2 which are output from the second storage unit STR2.

TABLE 2

| Second storage unit STR2 | Delay value (p value or q value) | |
|---|---|---|
| First output delay value OD1 | 0 | Synchronization with horizontal |
| or | | synchronization signal Hsync |
| second output delay value OD2 | 1 | 1 period delay |
| | 2 | 2 periods delay |
| | 3 | 3 periods delay |
| | 4 | 4 periods delay |
| | . . . | |
| | 10 | 10 periods delay |

Referring to Table 2, the first output delay value OD1 and the second output delay value OD2, which are values respectively delayed by p period and q period of the initiation clock signal CLK from a level change point of the horizontal synchronization signal Hsync, may be stored in the second storage unit STR2. For example, when p is 1 and q is 2, the first output delay value OD1 may be a value delayed by 1 period of the initiation clock signal CLK from the level change point of the horizontal synchronization signal Hsync, and the second output delay value OD2 may be a value delayed by 2 periods of the initiation clock signal CLK from the level change point of the horizontal synchronization signal Hsync. FIG. 9A illustrates a case where p is 0 and q is 2 as an example. In an embodiment of the invention, the (1-1)-th signal SG1-1 having the first output delay value OD1 may be synchronized with the horizontal synchronization signal Hsync, and the second signal SG2 having the second output delay value OD2 may be delayed by 2 periods of the initiation clock signal CLK from the level change point of the horizontal synchronization signal Hsync.

FIG. 9B illustrates a case where p is 1 and q is 2 as an example. In an embodiment of the invention, a (1-1)-th signal SG1-1′ having the first output delay value OD1′ may be delayed by 1 period of the initiation clock signal CLK from the level change point of the horizontal synchronization signal Hsync, and the second signal SG2 having the second output delay value OD2 may be delayed by 2 periods of the initiation clock signal CLK from the level change point of the horizontal synchronization signal Hsync.

In an embodiment of the invention, the data driving circuit 200 may separately adjust an r value corresponding to the first output delay values OD1 and OD1′ of the (1-1)-th signals SG1-1 and SG1-1′, and an r′ value corresponding to the second output delay value OD2 of the second signal SG2. Therefore, compared to a case where the r value and the r′ value are adjusted equally at the same time, the timings of two routes of the (1-1)-th signal SG1-1 and the second signal SG2 received by the source output unit SAMP may be adjusted more easily.

In an embodiment, for example, similarly to FIG. 2, the data voltage DV3 provided to one first pixel and one second pixel, which are connected to one data line DL3 and arranged adjacent to each other, may be switched (or changed). Here, a slew characteristic of a data voltage provided to the first pixel and a slew characteristic of a data voltage provided to the second pixel may be different from each other. The slew characteristic may indicate a data voltage change rate. When slew characteristics are different from each other, a phenomenon in which data voltages of adjacent gradations are reversed in a specific time period may occur. In an embodiment, for example, the specific time period may correspond to an initial time period in which the data voltage DV3 changes.

In an embodiment of the invention, the data driving circuit 200 may adjust the output timing of the (1-1)-th signals SG1-1 and SG1-1′ output from the first multiplexer MUX1 and the second signal SG2 output from the second multiplexer MUX2 to be different from each other. In an embodiment, for example, an update point of the second signal SG2 including lower bit data and an update point of the third signal SG3 may be delayed in a way such that the data voltages have substantially the same slew characteristic in the specific time period. Thereafter, when the third signal

SG3 and the second signal SG2 including the lower bit data are updated, the data voltages may be changed to respective target gradations after the specific time period. That is, the data voltages between adjacent gradations may be changed without reversal. Accordingly, the display quality of the electronic device 101 (see FIG. 2) may be improved.

FIGS. 9A and 9B illustrates the case where an r value corresponding to the first output delay values OD1 and OD1′, and an r′ value corresponding to the second output delay value OD2 are different from each other, but an embodiment of the invention is not limited thereto, and the r value and the r′ value may be the same.

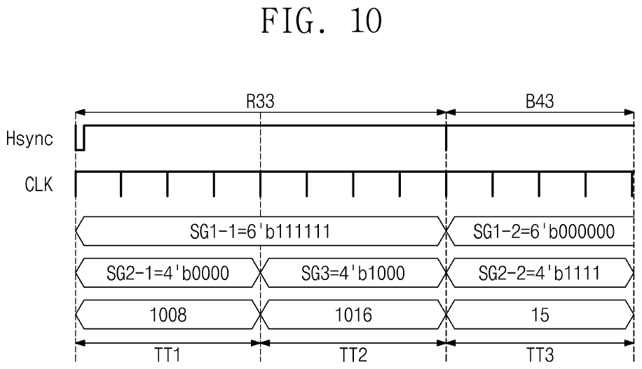

FIG. 10 is a signal timing diagram for describing a (1-1)-th signal SG1-1, a (1-2)-th signal SG1-2, a first second signal (hereinafter, will be referred to as “(2-1)-th signal”) SG2-1, a second second signal (hereinafter, will be referred to as “(2-2)-th signal”) SG2-2, and a third signal SG3 according to an embodiment of the invention. Each of the (1-1)-th signal SG1-1 and the (1-2)-th signal SG1-2 may be referred to as a first signal, and each of the (2-1)-th signal SG2-1 and the (2-2)-th signal SG2-2 may be referred to as a second signal.

FIG. 10 illustrates signals corresponding to one first pixel R33 and one second pixel B43 among the third column pixels R13, B23, R33, and B43 illustrated in FIG. 2 as an example. Hereinafter, the one first pixel R33 is referred to as a first pixel R33, and the one second pixel B43 is referred to as a second pixel B43.

Referring to FIGS. 2, 7, and 10, the first multiplexer MUX1 may receive the (1-1)-th signal SG1-1 corresponding to the first pixel R33 and the (1-2)-th signal SG1-2 corresponding to the second pixel B43. The second multiplexer MUX2 may receive the (2-1)-th signal SG2-1 corresponding to the first pixel R33 and the third signal SG3 output from the third storage unit STR3. FIG. 10 illustrates the case where the (1-1)-th signal SG1-1 and the (1-2)-th signal SG1-2 are configured to have 6 bits, and the (2-1)-th signal SG2-1, the (2-2)-th signal SG2-2, and the third signal SG3 are configured to have 4 bits.

In an embodiment of the invention, the (1-1)-th signal SG1-1 corresponding to the first pixel R33 may be output to in a first period TT1 and a second period TT2, and the (1-2)-th signal SG1-2 corresponding to the second pixel B43 may be output in a third period TT3. The (2-1)-th signal SG2-1 corresponding to the first pixel R33 may be output in the first period TT1, and the (2-2)-th signal SG2-2 corresponding to the second pixel B43 may be output in the third period TT3. The third signal SG3 may be output in the second period TT2.

The (1-1)-th signal SG1-1, the (1-2)-th signal SG1-2, the (2-1)-th signal SG2-1, and the (2-2)-th signal SG2-2 may be provided to the first pixel R33 and the second pixel B43 which are connected to one data line DL3 and arranged adjacent to each other. In an embodiment, for example, the (1-1)-th signal SG1-1 corresponding to the first pixel R33 and the (2-1)-th signal SG2-1 corresponding to the first pixel R33 may be provided to the first pixel R33 as a valid data voltage DV3 in the first period TT1. The valid data voltage DV3 provided to the first pixel R33 may be referred to as a first data voltage DV3.

In addition, the (1-2)-th signal SG1-2 corresponding to the second pixel B43 and the (2-2)-th signal SG2-2 corresponding to the second pixel B43 may be provided to the second pixel B43 as the valid data voltage DV3 in the third period TT3. The valid data voltage DV3 provided to the second pixel B43 may be referred to as a second data voltage DV3. Thus, a data voltage corresponding to data 1008 in the first period TT1 illustrated in FIG. 10, which is data including the (1-1)-th signal SG1-1, the (1-2)-th signal SG1-2, the (2-1)-th signal SG2-1, and the (2-2)-th signal SG2-2, may be provided to the first pixel R33, and a data voltage corresponding to data 15 in the third period TT3 may be provided to the second pixel B43.

In an embodiment of the invention, the third signal SG3 may be output between the first period TT1 in which the (2-1)-th signal SG2-1 is output to the first pixel R33, and the third period TT3 in which the (2-2)-th signal SG2-2 is output to the second pixel B43. The third signal SG3 may be output subsequently to the (2-1)-th signal SG2-1, and may include interpolation data between the (2-1)-th signal SG2-1 and the (2-2)-th signal SG2-2 which are provided to the first pixel R33 and the second pixel B43. Accordingly, the third signal SG3 may not be provided to the first pixel R33 and the second pixel B43. Therefore, a data voltage corresponding to data 1016 of the second period TT2 illustrated in FIG. 10, which is data including the (1-1)-th signal SG1-1, the (1-2)-th signal SG1-2, and the third signal SG3, may not be provided to the first pixel R33.

In an embodiment of the invention, the third signal SG3 may have a value between the (2-1)-th signal SG2-1 corresponding to the first pixel R33 and the (2-2)-th signal SG2-2 corresponding to the second pixel B43. In an embodiment, for example, the (2-1)-th signal SG2-1 corresponding to the first pixel R33 may be 0000, the (2-2)-th signal SG2-2 corresponding to the second pixel B43 may be 1111, and the third signal SG3 may be 1000, which is a value between 0000 and 1111. According to embodiments of the invention, since the third signal SG3 is not previous data but is received separately from the third storage unit STR3, the circuit is designed in a way such that a data peak, which would occur during switching of data voltages transferred respectively to the adjacent first pixel R33 and second pixel B43, is reduced, or does not occur. Resultantly, the display quality of the electronic device 101 (see FIG. 2) may be improved.

According to embodiments of the disclosure above, an electronic device may include a display panel having a plurality of pixels electrically connected to one data line, and a data driving circuit for outputting a data voltage to the one data line. The data voltages provided to the pixels which are connected to the one data line may be switched consecutively.

The data driving circuit may use a signal, which is not previous data but stored separately, to provide an interpolation data voltage to a superposition section of the data voltages corresponding to two adjacent pixels. Thus, a data peak caused by superposition of the data voltages may not occur, or be reduced. Resultantly, the display quality of the electronic device may be improved.

In such embodiments, the data driving circuit may control respective output timings of the data signals corresponding to two adjacent pixels to be different from each other. Thus, the data signals may be adjusted to have substantially the same slew characteristic, and the data voltages between adjacent gradations may be converted without reversal. Accordingly, the display quality of the electronic device may be improved.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An electronic device comprising:
a display panel including a plurality of pixels electrically connected to one data line; and
a data driving circuit which outputs a data voltage to the one data line,
wherein the data driving circuit includes
an input unit which receives a plurality of data from an outside and outputs a data signal composed of a plurality of bits,
a first multiplexer which receives a first signal including x upper bit data among the plurality of bits,
a second multiplexer which receives a second signal including y lower bit data among the plurality of bits, and
a source output unit which receives the first signal from the first multiplexer and the second signal from the second multiplexer and generates the data voltage,
and
a first output delay value of the first signal output from the first multiplexer is different from a second output delay value of the second signal output from the second multiplexer.

2. The electronic device of claim 1, wherein the data driving circuit further comprises a decoder which converts the data signal to the first signal and outputs the first signal to the first multiplexer.

3. The electronic device of claim 2, wherein the data driving circuit further comprises a first storage unit in which a gamma reference value is stored, and
the decoder converts the data signal using the gamma reference value.

4. The electronic device of claim 1, wherein each of the first output delay value and the second output delay value is a value delayed from a level change point of a horizontal synchronization signal.

5. The electronic device of claim 1, wherein the data driving circuit further comprises a second storage unit in which the first output delay value and the second output delay value are stored.

6. The electronic device of claim 1, wherein the second multiplexer further receives a third signal including y interpolation bit data, and
the third signal is output subsequently to the second signal.

7. The electronic device of claim 6, wherein the data driving circuit further comprises a third storage unit in which the y interpolation bit data is stored.

8. The electronic device of claim 6, wherein the plurality of pixels comprise a plurality of red pixels and a plurality of blue pixels arranged in a first direction, and
the plurality of red pixels and the plurality of blue pixels are alternately arranged one by one along the first direction.

9. The electronic device of claim 6, wherein the source output unit receives the first signal and the third signal and further generates an interpolation data voltage.

10. The electronic device of claim 1, wherein the data driving circuit further comprises:
a determination unit which determines x value and y value of the x upper bit data and the y lower bit data, respectively; and
a fourth storage unit in which the x value and the y value are stored.

11. The electronic device of claim 1, wherein the input unit further comprises:
a shift register unit which outputs a plurality of clock signals sequentially;
a sampling latch unit which stores the plurality of data sequentially in response to the plurality of clock signals; and
a holding latch unit which receives a load signal and outputs the plurality of data received from the sampling latch unit in response to the load signal.

12. The electronic device of claim 11, wherein the input unit further comprises a level shifter which receives the plurality of data from the holding latch unit and changes voltage levels of the plurality of data.

13. An electronic device comprising:
a display panel including a first pixel electrically connected to one data line, and a second pixel connected to the one data line and arranged adjacent to the first pixel in a first direction; and
a data driving circuit which provides a first data voltage to the first pixel and provides a second data voltage to the second pixel,
wherein the data driving circuit includes
an input unit which receives a plurality of data from an outside and outputs a data signal composed of a plurality of bits,
a first multiplexer which receives a first signal including x upper bit data among the plurality of bits,
a second multiplexer which receives a second signal including y lower bit data among the plurality of bits and receives a third signal including y interpolation bit data separately stored, and
a source output unit which receives the first signal and the second signal to generate the first data voltage and the second data voltage, and receives the first signal and the third signal to generate an interpolation data voltage,
a first output delay value of the first signal output from the first multiplexer is different from a second output delay value of the second signal output from the second multiplexer, and
each of the first output delay value and the second output delay value is a value delayed from a level change point of a horizontal synchronization signal.

14. The electronic device of claim 13, wherein the data driving circuit further comprises a decoder which converts the data signal to the first signal and outputs the first signal to the first multiplexer.

15. The electronic device of claim 14, wherein the data driving circuit further comprises a first storage unit in which a gamma reference value is stored, and the decoder converts the data signal using the gamma reference value.

16. The electronic device of claim 13, wherein the data driving circuit further comprises a second storage unit in which the first output delay value and the second output delay value are stored.

17. The electronic device of claim 13, wherein the third signal is output subsequently to the second signal.

18. The electronic device of claim 13, wherein the data driving circuit further comprises:
a determination unit which determines x value and y value of the x upper bit data and the y lower bit data, respectively; and
a fourth storage unit in which the x value and the y value are stored.

19. The electronic device of claim 13, wherein the input unit further comprises:
a shift register unit which outputs a plurality of clock signals sequentially;
a sampling latch unit which stores the plurality of data sequentially in response to the plurality of clock signals;
a holding latch unit which receives a load signal and outputs the plurality of data received from the sampling latch unit in response to the load signal; and
a level shifter which receives the plurality of data from the holding latch unit and change voltage levels of the plurality of data.

20. An electronic device comprising:
a display panel including a plurality of pixels electrically connected to one data line;
a processor which outputs a control signal to control an operation of the display panel;
a memory in which an x value and a y value are stored;
an input unit which receives a bit determination signal including the x value and the y value from the memory based on the control signal, and outputs a first data signal including x upper bit data and a second data signal including y lower bit data;
a first multiplexer which receives a first signal based on the first data signal;
a second multiplexer which receives a second signal based on the second data signal; and
a source output unit which receives the first signal from the first multiplexer and the second signal from the second multiplexer and generates a data voltage,
wherein a first output delay value of the first signal output from the first multiplexer is different from a second output delay value of the second signal output from the second multiplexer.
